(19) United States
(12) Patent Application Publication
(10) Pub. No.: US 2006/0064756 A1
(43) Pub. Date: Mar. 23, 2006

(54) Digital rights management system based on hardware identification

(76) Inventor: Robert F. Ebert, San Francisco, CA (US)

Correspondence Address: CARR & FERRELL LLP, 2200 GENG ROAD, PALO ALTO, CA, 94303, US

(21) Appl. No.: 10/943,392

(22) Filed: Sep. 17, 2004

(51) Int. Cl. H04N 7/16

(52) U.S. Cl. 726/26

(57) ABSTRACT

A method for digital rights management is provided. The method is used for managing the right to use a digital software application having a main code component including application code and data resources. The method generates a security component including a hardware identification attribute and appends the security component to the main code component to form a software application package. When the software application package is installed on a hardware device, the security component enables the software application only if the hardware identification attribute is also present in the hardware device.

### CROSS-REFERENCE TO RELATED APPLICATIONS

The present disclosure is related to U.S. patent application Ser. No. ______ entitled “Electronic Software Distribution Method and System Using a Digital Rights Management Method Based on Hardware Identification” (Attorney Docket No. PA2805US) filed on even date herewith.

### BACKGROUND OF THE DISCLOSURE

1. Field of the Invention

The present disclosure relates generally to the field of Digital Rights Management (DRM) and more particularly to methods, apparatuses and systems to digitally manage user rights of digital contents such as software applications.

2. Description of the Prior Art

Digital Rights Management (DRM) poses one of the greatest challenges in this digital age for the owners of property rights that either exist in a digital form or can be managed by a digital method. The challenges posed by DRM are different than those found in traditional rights management. Traditional rights management usually involves content embodied in some tangible medium that has a certain degree of physicality that is hard to change and thus provides some barrier to unauthorized exploitation of the content. In contrast, digital media provide little barrier to the unauthorized exploitation of content embodied therein. Thus, the same technology that allows digital content to be created also makes it extremely easy to copy that content. In addition, because a digital copy is typically identical to the original, successive generations do not suffer deterioration or degradation of quality, further enabling unauthorized copies of digital content to be readily made. As a result of unauthorized copying, software sold to a single customer may end up in the hands of, and used by, many unauthorized users. This may occur either through unauthorized production and distribution of counterfeit copies of the software or through file distribution at individual levels such as unscrupulous sharing among people.

In addition to the issue of authorization (e.g. unauthorized copying), digital content communicated through a network also faces the issue of authentication. Network-communicated digital content is subject to third-party tampering, for example, through eavesdropping, alteration, impersonation and spoofing. The issue of authentication is a particularly serious one over the Internet. The Internet uses the Transmission Control Protocol/Internet Protocol (TCP/IP) to allow information to be routed from an originating computer to a destination computer through a variety of intermediate computers and separate networks. The routing characteristics of the Internet make it possible for a third party to interfere with communications.

It will be appreciated, therefore, that means of retaining or enforcing the property control over digital content is necessary if there is to be viable commerce based upon the distribution of valuable digital content. Digital Rights Management (DRM) methods answer the above challenge using a variety of techniques including both software solutions and hardware solutions. The existing Digital Rights Management (DRM) methods focus on security and encryption as a means to prevent or frustrate unauthorized copying.

FIG. 1 shows the general concept of a typical DRM procedure used for protecting a software application from unauthorized uses. According to this procedure, a software application is encrypted by a vendor. Unless decrypted, the encrypted software application is either entirely unusable or can only be used in a restricted form. At step 100, a user receives a copy of the encrypted software application. The user obtains proper digital rights to the encrypted software application in step 102 in order to fully use the software application. A digital right is generally issued by a rights issuer, such as the vendor, and contains necessary means or information to decrypt the encrypted software application. Upon acquiring the necessary digital rights from the rights issuer, in step 104 the user decrypts the encrypted software application. In step 106 the decrypted software application is available to be properly used, e.g., the application can execute upon suitable user hardware.

A variety of methods may be used to implement the above general concept, particularly encryption and decryption. Encryption of the software application is commonly accomplished using a set of well-established techniques and standards known as public/private-key cryptography.

FIG. 2 shows a prior art example of such implementation. First, as indicated at step 200, the publisher or the vendor of digital content seals the digital content with encryption and/or digital signatures. At step 202, the encrypted digital content is circulated or distributed via electronic distribution channels, e.g. web, e-mail, Usenet, ftp, CD-ROM, etc. At step 204, upon acquiring a copy of the encrypted digital content, a user requests rights, often in the form of a digital certificate, from a DRM server. At step 206, upon verifying the authorization status of the user, the DRM server issues rights containing the required decryption keys, certificates and the usage specifications to the user. At step 208, the user then uses the decryption information contained in the required digital rights to decrypt the digital content. Finally at step 210, the user has access to the decrypted digital content upon suitable user hardware.

Two problems often occur with the above-described DRM methods. First, digital rights such as digital certificates containing decryption information are themselves unprotected once issued. Anyone who has a copy of the digital certificate containing decryption information can use it to decrypt the encrypted digital content which is often freely distributed or at least subject to unauthorized distribution. Underground manufacturers sometimes make pirate copies of the digital content and provide decryption information to their customers. On a smaller scale, unscrupulous users may also pass the decryption information to others without authorization. Second, digital certificates often involve entering and verifying long alphanumeric keys or pass phrases, creating a somewhat frustrating user experience and prevents automation.

Given the crucial role DRM plays in the commerce of digital content such as electronic software distribution (ESD), it is desirable to have a DRM method or system that provides robust protection while at the same time affording better automation and a more pleasant user experience.

### SUMMARY

The present disclosure provides a method for digital rights management (DRM). The method starts with a main code component of a software application. The main code component has application code and data resources. A security component including a hardware identification attribute is then generated and appended to the main code component to form a software application package. When the software application package is installed on a hardware device, the software application is enabled if the hardware identification attribute is also present in the hardware device, and is disabled if the hardware identification attribute is not present in the hardware device.

In one embodiment, the hardware identification attribute is automatically determined for the purpose of generating the security component. For example, the hardware identification attribute may be stored in the hardware device and automatically determined and communicated through electronic means. Alternatively, the hardware identification attribute is automatically determined by matching a user identification with a database that contains records for hardware identification attributes associated with respective user identifications. In one embodiment, the security component is a digital hardware signature generated using a data set and a key. The digital hardware signature can be validated only using a hardware device that has a matching hardware identification attribute.

The method is particularly suitable for distributing software application packages in downloadable executable files, such as a PalmOS resource file (.prc) used on handheld devices based on a Palm operating system (e.g., PDAs and handheld game consoles).

The present disclosure also provides a DRM system that includes a hardware device including a hardware identification attribute and a software application having a main code component and a security component appended to the main code component. The security component includes a matching hardware identification attribute, such that the software application is enabled if installed on the hardware device and disabled if installed on a hardware device that does not include a matching hardware identification attribute.

In one embodiment, the hardware identification attribute is unique to the hardware device, such that the software application is disabled if installed on any other hardware device. The hardware device can be a portable device such as a handheld computer, PDA or a handheld game console. The hardware identification attribute may also be that of a removable ROM or RAM device.

The present disclosure also provides a DRM system using servers. A first server is used for receiving a set of user data from which a hardware identification attribute can be determined, while a second server is used for generating, upon receiving a request from the first server, a digital hardware signature based on the set of user data. The digital hardware signature includes the hardware identification attribute. Either of the first or second servers is configured to append the digital hardware signature to a software application to form a software application package which is executable on a hardware device only when the hardware device has a matching hardware identification attribute. In one embodiment, the first server is an Electronic Software Distribution server that stores the software application component, and the second server is a digital signature server that stores private keys for generating the digital hardware signature. The digital signature server can be configured to return the generated digital hardware signature to the Electronic Software Distribution server to form the software application package.

As disclosed herein, the DRM method in accordance with the present disclosure uses a digital cryptographic signature to carry out a unique “reverse validation” of a digital cryptographic signature. Because the hardware signature is appended to the main code component of the software application to form a software application package, no separate DRM certificate is necessary for a user to be authorized to use a software application. The simplicity of digital hardware signature validation makes possible an automated DRM method or system that enables a uniquely packaged software application to an authorized hardware device yet without requiring the user to remember or enter a license key or license code. Furthermore, according to the present invention, maintaining digital rights no longer requires encryption of the main code component of the software application, although encryption still can be used.

Other features and advantages of the disclosure will become more readily understandable from the following detailed description and figures.

### BRIEF DESCRIPTION OF DRAWINGS

The DRM method and system of the present disclosure will be described in detail along with the following figures, in which like parts are denoted with like reference numerals or letters.

FIG. 1 shows a DRM procedure used for protecting a software application from unauthorized use according to the prior art.

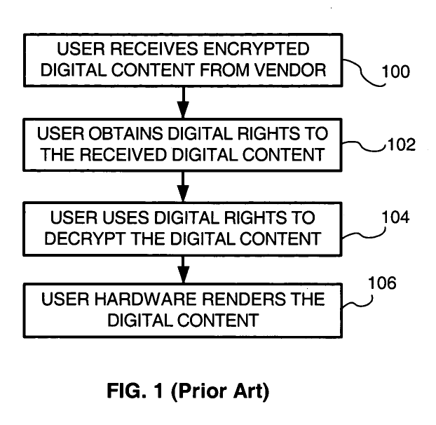

FIG. 2 shows an implementation of the DRM procedure of FIG. 1 according to the prior art.

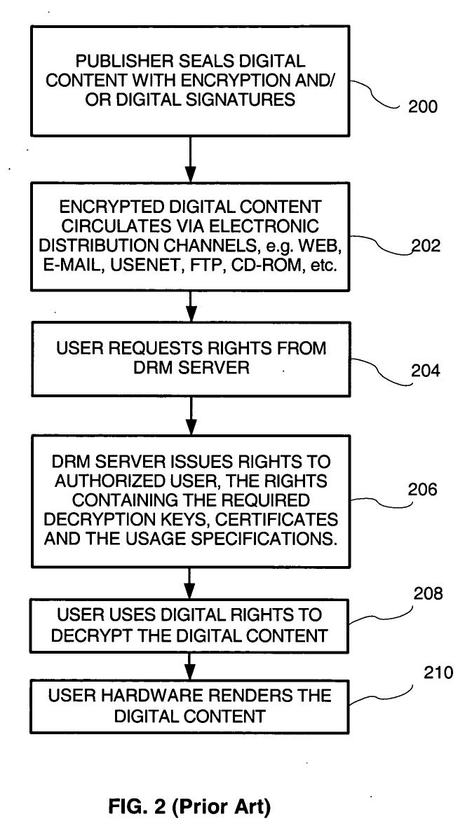

FIG. 3 is a flow-chart representation of a DRM method according to an embodiment of the present invention.

FIG. 4 is a schematic illustration of an exemplary embodiment of a DRM method according to the present invention.

FIG. 5 is a schematic illustration of an exemplary implementation of a DRM method according to the present invention.

### DETAILED DESCRIPTION OF THE DISCLOSURE

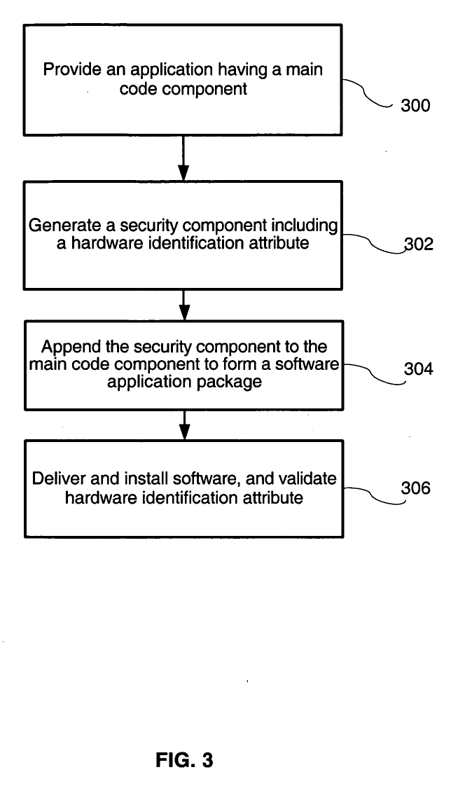

The present invention provides DRM methods and systems based on hardware identification. FIG. 3 provides an overview of an exemplary DRM method in the form of a flow-chart. At step 300 a software application having a main code component is provided. A security component, including a hardware identification attribute, is generated at step 302. Then, at step 304, the security component is appended to the main code component to form a software application package. At step 306, the software application package is installed on a hardware device, whereby the security component functions such that the software application is enabled if the hardware identification attribute is also present in the hardware device, and is disabled if the hardware identification attribute is not present in the hardware device.

Representative embodiments of the DRM methods and systems are discussed below to illustrate the invention. The disclosed methods or systems should not be construed as limiting in any way. Although the examples use a software application in the format of an executable PalmOS resource file (.prc), the methods and the systems in accordance with the present disclosure are not limited to this file type.

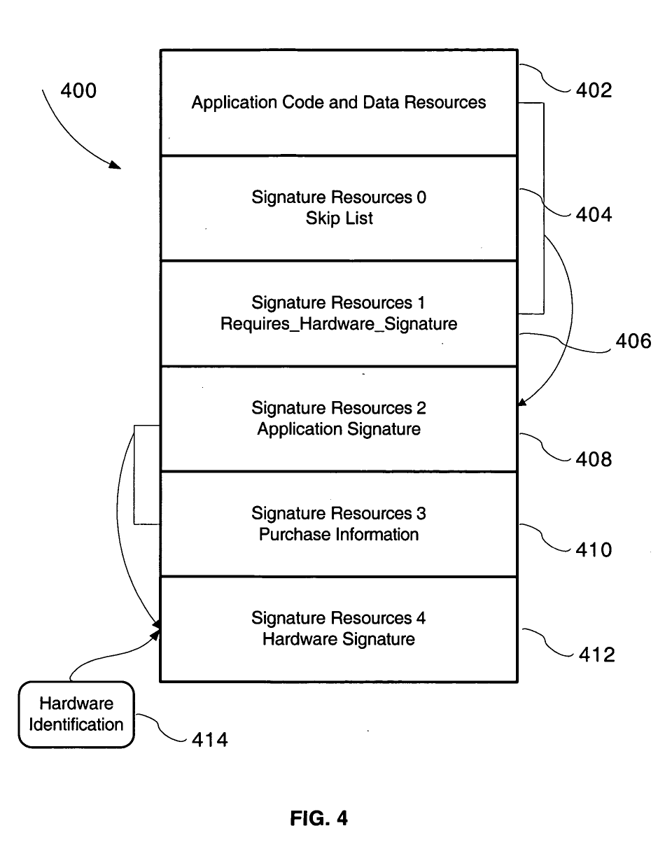

FIG. 4 is a schematic illustration of an embodiment of a DRM method used to produce a copy-protected software application 400, which in this particular example is an executable PalmOS resource file package that can be rendered on any electronic device having a Palm operating system (Palm OS) or a compatible operating system. Palm OS applications have traditionally been developed using the 68K-based application programming interfaces (APIs) for handheld devices with 68K-family processors. Subsequent Palm OS releases (release 5 or higher) are designed for handheld devices with ARM-based processors. Software application 400, in accordance with the present disclosure, is not limited to applications for any particular hardware architecture and may be designed to be suitable for any Palm architecture, including the classic 68K architecture and ARM-based architecture.

Software application 400 includes main code component 402, which is a collection of application code and data resources. Like any PalmOS resource file, software application 400 may also include PRC header and PRC resource headers; such headers are omitted from FIG. 4 for clarity.

Software application 400 further includes multiple Signature Resources 404, 406, 408, 410 and 412 (Signature Resources 0, 1, 2, 3, and 4 respectively). In particular, among these Signature Resources is hardware signature 412 (Signature Resources 4) which is a security component including a hardware identification attribute. Hardware signature 412 (Signature Resources 4) is described below, while the other Signature Resources are discussed in a later section of this disclosure.

In one embodiment, hardware signature 412 is an encrypted digital signature created from a hash and a key. Hardware signature 412 includes a hardware identification attribute, such as a serial number or a model number, that can at least partially identify a specific hardware device (not shown in FIG. 4) to be authorized to execute software application 400. The hardware identification attribute may be determined from hardware identification 414, or purchase information 410, or a combination of both.

Like other Signature Resources components, hardware signature 412 is appended to the main code component 402 to form a packaged software application 400. This is different from existing techniques which use some form of “equipment node” to tie an application to a user's hardware device and require that the user separately obtain from a key issuer a DRM certificate and a DRM private key. By contrast, hardware signature 412 becomes a part of the packaged software application 400 and forms the basis of a reverse signature validation mechanism as described herein to verify an authorized hardware device. It should be noted that there is no requirement to encrypt the software application 400, although it can be.

After the software application 400 has been installed on a hardware device such as a Palm device (not shown in FIG. 4), upon execution the software application 400 automatically verifies whether the hardware signature 412 can be validated by the specific hardware device. If the validation is successful, software application 400 is enabled, meaning that it is fully functional. However, if the validation is unsuccessful, software application 400 is disabled meaning that either execution terminates or the software application 400 enters into a restricted mode that offers less than full functionality.

The exemplary hardware signature 412 can only be validated with a validating key that matches the key use for generating hardware signature 412. In some embodiments, hardware signature 412 is generated using a private key and validated by a public key stored on the hardware device. The hardware signature 412 includes a data set including a hardware identification attribute and can only be validated if the same hardware identification attribute is present on the hardware. As a result, software application 400 is enabled (i.e., fully executable) if the hardware identification attribute is also present in the hardware device, and is disabled (either wholly unexecutable or only partially executable) if the hardware identification attribute is not also present in the hardware device. It will be appreciated that because the hardware signature 412 is constrained to a hardware device having a specific hardware identification attribute, copies of software application 400 will only be unlocked when executed by the hardware device having the specific hardware identification attribute.

It will be appreciated that in the above embodiments, the validating key is not required to include a hardware identification attribute. The same validating key can be shared by many hardware devices. The hardware-specific security in these embodiments thus comes from a secure private key and the hardware-specificity of the data set of the hardware signature 412.

Standard cryptography techniques, such as RSA asymmetric key technique, can be used to associate a hardware identification attribute with the hardware signature 412. For example, a hardware device may be identified using a hardware identification that includes several hardware identification attributes. An alphanumeric string may be determined from the hardware identification attribute and is included as a part of the signature data set to be validated. During validation, codes embedded in an operating system of the hardware device generate another data set and compare the new data set with the original signature data set. If the same hardware identification attribute is present on the hardware device, the new data set would be identical to the original signature data set, thus successfully validating the hardware signature. If the same hardware identification attribute is not present on the hardware device, the new data set generated by the operating system on the hardware device would not match the original signature data set, and the validation of the hardware signature fails.

In other embodiments, the key pair used to generate hardware signature 412 is designed such that a matching key can only be found on a hardware device that has a specific hardware identification attribute. The signature keys can be determined such that both include the same hardware identification attribute, or attributes, from amongst the several hardware identification attributes of the hardware device. This method, however, is less preferred because it makes it difficult to apply standard cryptography techniques. For example, the standard RSA asymmetric key technology has its own rules for selection of keys, leaving little room for hardware specific keys.

It will be understood that the hardware identification attribute itself is not required to be an alphanumeric string, nor is the hardware identification attribute itself required to literally constitute a part of the security component, the hardware signature, or the key. The phrases “including a hardware identification attribute” or “having a hardware identification attribute” only mean that the security component, the hardware signature, or the key is determined using the hardware identification attribute as an input and is thus associated with the hardware identification attribute. For example, a hardware signature including a hardware identification attribute means that the hardware signature, which is generated from a data set, is either determined using a certain algorithm such that the hardware signature is a function of the hardware identification attribute, or a corresponding signature key for the hardware signature is encrypted and can only be decrypted by using another key that is determined as a function of the hardware identification attribute. The hardware identification attribute does not have to be an alphanumeric string but must contain proper information that is capable of uniquely determining an alphanumeric string.

In a simpler form, however, the hardware identification attribute may indeed be an alphanumeric string, or even a straight number, such as a serial number. In this case, the hardware identification attribute may be directly inserted into the signature data set to be validated. Alternatively, one of the keys can simply be the same number as the serial number, or at least incorporate the serial number as a part of the key, while the other key in the pair is determined from the first key using standard cryptographic techniques.

In a more sophisticated form, the hardware identification attribute may be indirectly incorporated into the hardware signature or a key that validates the hardware signature. For example, in the case where a serial number of the hardware device is used as the hardware identification attribute, the key which validates the hardware signature may be an authorization key that is different than, or even has no direct relationship with, the serial number but nevertheless indirectly incorporates the serial number. For example, the authorization key for validating the hardware signature is encrypted such that the serial number of the hardware device functions as a decryption key (or at least constitutes a part of the decryption key) to decrypt the authorization key, which in turn is used to decrypt the hardware signature. Using this indirect method to incorporate the hardware identification attribute into the hardware signature can afford more flexibility.

For example, in some cases an authorized user needs to use a different hardware device either because the user has lost the previously authorized hardware device or has upgraded to a new hardware device. In such instances, the user only needs to obtain from the vendor a new encrypted authorization key which can be decrypted using the hardware identification attribute (the serial number in this example) of the new hardware device and does not have to obtain an entirely new software application package. In comparison, if the hardware identification attribute (e.g., a serial number) has been directly used as the validating key of the hardware signature, the user would have to obtain a new software application package including a new hardware signature in the above scenario.

In one embodiment, the signing key for generating the hardware signature is a private key while the validating key use for validating the hardware signature is a public key.

Any suitable cryptographic technique can be used for the necessary encryption/decryption of the DRM methods of the present disclosure. A suitable example is industry-standard and industrial-strength Public-Key Cryptography Standards (PKCS) from RSA Security. As known in the art of cryptography, encryption is a process of transforming information from an original form to a form that is unintelligible to anyone but the intended recipient. Decryption is the process of transforming encrypted information back to the original intelligible form. Encryption and decryption are mathematical operations performed on digital content using cryptographic algorithms, which are mathematical functions. An encryption function and its matching decryption function are related mathematical operations. In key-based cryptography, encryption or decryption can be performed only with the combination of both a right cryptographic algorithm and a right cryptographic key. Cryptographic keys are long numbers. Because cryptographic algorithms themselves are usually widely known, the ability to keep encrypted information secret is not based on the secrecy of a particular cryptographic algorithm but on the secrecy of the cryptographic key that must be used with that algorithm to produce an encrypted result or to decrypt previously encrypted information.

Both symmetric-key encryption and asymmetric encryption may be used, but asymmetric encryption is preferred. The latter is also called public/private-key encryption because the method uses a pair of two different keys, one made public while the other kept secret (private). The pair of keys, namely the public key and the private key, are associated with an entity that needs to authenticate its identity electronically or to sign or encrypt data. Data encrypted with one key in the pair can be decrypted only with the matching key in the pair. Decryption with the correct key is simple. Decryption without the correct key is very difficult, and in some cases impossible for all practical purposes. As well known in the art, in association with and in addition to content encryption, key-based cryptography is also used for digital signatures and digital certificates. For this purpose, the private key is conventionally used for the signing function while the public key is used for the validating function. More specifically, in a conventional application of digital signatures, the public uses the public key to verify the identification of the entity who has executed the signature using the corresponding private key. In a preferred embodiment of the present invention, a private key is used to sign a data stream including the hardware ID, creating the hardware signature, while a public key is used to reversely verify the same data stream on the device, thus proving the authorization for the hardware was issued by the vendor.

The hardware device, whose hardware identification attribute is used to generate the hardware signature, may be any electronic device, such as a PC, a handheld computer, a game console, or a portable game console, that is capable of running the software application given proper authorization. Alternatively, the hardware device, whose hardware identification attribute is used to generate the hardware signature, can be a storage device such as a removable ROM or RAM card (such as an SD or MMC flash card) that stores the software application. In some embodiments, the software application executes on a host hardware device when the removable storage device storing the software application is connected to the host hardware device.

In some embodiments, the hardware identification attribute is desirably capable of uniquely identifying every hardware device in a hardware group. The hardware group can comprise a group of devices sold together to a single client, a particular hardware device model, a certain class of hardware devices, or can broadly encompass all hardware devices that are suitable for running the software application. In these embodiments, where the software application is intended to be run on any member of a hardware group, a hardware identification attribute common to the hardware group or hardware domain may be used.

The hardware identification attribute is desirably present on, or determinable from, the hardware device itself. For example, the hardware identification attribute can be a piece of electronic data stored on the hardware device. The stored data is desirably persistent so that it is not easily changeable. For example, the persistent attribute may be a serial number stored in a ROM memory element of the hardware device. The hardware identification attribute is further desirably created during the manufacture of the hardware device and difficult to access subsequently.

Referring again to FIG. 4, software application 400 also includes a special resource 406 (Signature Resources 1) named, for the purposes of this example, Requires_Hardware_Signature. The presence of special resource 406 instructs the operating system to validate hardware signature 412. Hardware signature validation is performed at least once when the software application 400 is first launched. In one embodiment, special resource 406 instructs the operating system to validate hardware signature 412 periodically during the execution of the software application 400. This assures that the software application 400 continues to runs on an authorized hardware device and has not, for instance, been started on an authorized hardware device and subsequently transferred or copied to an unauthorized one. Alternatively, in a case where the authorizing hardware device is a removable device, this assures that the authorizing hardware device continues to be present and has not been removed after the software application 500 has been started.

Special resource 406 can further include information for the version of the software application 400, the hardware, and the hardware signature 412. Special resource 406 can further include permission-type information. For example, a byte reserved for the permission-type information may be set to different values to indicate various permission types including the following or a combination thereof:
“none allowed” in which the software application is permanently disabled;
“device signature required” in which the operating system is instructed to look for a matching key in the hardware device executing the software application to validate the hardware signature;
“card signature required” in which the operating system is instructed to look for a matching key in a ROM or RAM card on which the software application is stored to validate the hardware signature
“allow device or card locking” in which the operating system is instructed to look for a matching key to validate the hardware signature in either an executing hardware device or in a ROM or RAM card; and
“allow any locking type” in which the operating system is instructed to look for a matching key in any hardware device that is at least partially used to execute the software application.

Special resource 406 may also include instructions regarding how the software application 400 should function if the hardware signature validation fails. For example, a byte reserved for this information may be set to different values to instruct the operating system to either terminate the software application 400, reset the hardware device that runs the software application 400, terminate the software application 400 and reset the hardware device, or run the software application 400 in a restricted fashion such as a degraded demo mode.

As known in cryptography, generating a digital signature requires a hash in addition to a signing key. A digital signature is essentially an encrypted hash along with other information, such as the hashing algorithm. Hash is usually generated using a mathematical function called hashing operated on a data set. A hash is a numeric representation of the data set and therefore often called a data digest or a message digest. A hash is a number of fixed length. The value of the hash is unique for the hashed data. Any change in the data, even deleting or altering a single character, results in a different hash value. The most commonly used hashing algorithms generate a “one-way hash” in that, while the hash is generated from the hashed data set, the content of the hashed data cannot, for all practical purposes, be deduced from the hash.

As is known in art, hashing may be either performed as a separate step or as an integral part of signing or validating step.

In one embodiment, hardware signature 412 is generated using a hash of a data set comprising an application signature, which is a digital signature signed over the main code component of the software application 400. The application signature is also appended to and becomes a part of the packaged software application 400. The generation of such an application signature and its relation to the hardware signature in accordance with the present disclosure is further discussed below.

Referring again to FIG. 4, software application 400 includes application signature 408 (Signature Resources 2), which may be generated using standard cryptography techniques such as an asymmetric public/private key method. The application signature 408 may be used to protect the integrity of main code component 402 (application code and data resources), In one embodiment, a chosen algorithm is used to generate application signature 408 based on an application hash and a predetermined private key. The application hash is an encryption hash generated from at least part of main code component 402. The operating system of the hardware device that runs the software application is instructed to validate application signature 408 to ensure that the application has not been tampered with or modified since it was signed.

In another embodiment, a hash is generated using a few application particulars (such as the application name, version, and creator ID), and the generated hash is used to select a key pair from a pool of keys. Using this method, the key pair used for application signature is at least partially determined by the application particulars, and a different key pair may be used for a different type of application. This adds some security because two applications are less likely to use the same key pair. If one key pair is compromised, not all applications are breached.

For higher security, application signature 408 is preferably generated using a private key and validated using a public key. The private key can be chosen from a pool of keys that are carefully selected and kept secret by a controlling entity, which can be a developer, a distributor, a publisher, a retailer, but more preferably an entity (such as a manufacturer) who has a centralized control over multiple developers, distributors, publishers or retailers. Because the primary function of an application signature described herein is to verify authentication rather than authorization, the public key used for validation of the application signature is preferably well published, easily accessible and without unnecessary restrictions on specific hardware devices.

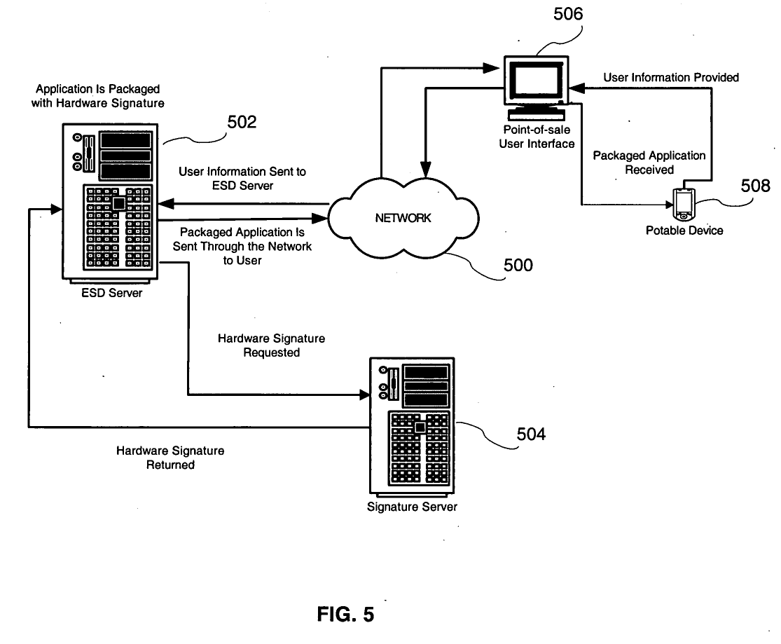

Further optionally, the data set used to generate the hash for hardware signature may also include purchase information 410, which is provided by either a retailer or a purchaser as illustrated in the exemplary DRM system shortening FIG. 5.

Software application 400 also includes skip list 404, which is a special resource to instruct which parts of the software application may be used to generate the hash for the application signature 408 and which parts may be skipped. The parts that are used to generate the hash will be digitally signed, or “sealed” and may not be modified after hardware signature 408 has been created, while the parts that are skipped may still be modified. For example, skip list 404 identifies the application resources that are subject to modification during application execution and therefore must be excluded from the generation of the application signature 408. An example of such an application resource is a data resource used for saving a registration code provided by the user.

An application resource may be configured to be automatically included in the skip list 404 by planting a data signal in the application resource. For example, the software application 400 may be configured so that it treats an application resource as being automatically in the skip list if the most significant bit (MSB) of the application resource is set to “1.” On the other hand, certain application resources, such as Signature Resourcess, may be pre-excluded from the skip list and thus always included in the generation of the application signature 408.

Additional steps can also be taken to enhance the security of software application 400. For example, any of the Signature Resources components (404, 406, 408, 410 and 412), but especially application signature 408 and hardware signature 412, can be merged with the main code component 402 such that the main code component 402 cannot be separately executed even if the main code component 402 is non-encrypted or decrypted. Custom codes and additional signatures may be added to provide further assurance that software application 400 cannot be disassembled, stripped of DRM security components (such as hardware signature 412), and then reassembled as an unprotected application. For example, custom signatures may be created from one or more data resources or code resources within the software application 400, and included within the software application 400. When the software application 400 runs on a hardware device, custom code within the application uses APIs to validate these custom signatures. These validations may be performed at various places and times within the software application code to make tampering with the application code increasingly difficult.

Finally, software application 400 may be packaged in any desirable file format or medium, such as a copy on a CD-ROM, a copy on a ROM or RAM card, or a downloadable executable file. For a software application 400 used on handheld device running the Palm OS, the packaged software application 400 is desirably a PalmOS resource file (.prc).

FIG. 5 is a schematic illustration of an exemplary DRM system of servers connected over a network for implementing the DRM method of the invention. The DRM system includes network 500, which may be any type of an electronic communications network but desirably is an Internet-based network. The DRM system further includes Electronic Software Distribution (ESD) server 502, signature server 504, an end user terminal 506, and a portable device 508.

In one embodiment, ESD server 502 stores a collection of unpackaged applications (not shown in FIG. 5) that have been developed by one or more developers. Each unpackaged application has a main code component including application code and data resources. The unpackaged applications are either bare-bones applications without any security components, or partially secured applications having an application signature but not a hardware signature.

In an illustrative process, the DRM system in FIG. 5 packages a software application as follows. ESD server 502 receives purchase information and a set of user data from which a hardware identification attribute can be determined. ESD server 502 then sends a request for a hardware signature to signature server 504. The hardware signature request includes the user data and specifies which software application has been ordered. Upon receiving the hardware signature request, signature server 504 first determines the hardware identification attribute (if it has not already been determined by ESD server 502) and then generates a digital hardware signature based on the set of user data. The digital hardware signature thus generated includes the hardware identification attribute. Next, signature server 504 returns the generated digital hardware signature to ESD server 502, which appends the digital hardware signature to the ordered software application to form a corresponding software application package.

An example of such a packaged software application has been illustrated in FIG. 4. The software application thus packaged is executable on a hardware device only when the hardware device has a matching hardware identification attribute. ESD server 502 then dispenses or distributes the packaged software application to an intended party such as a buyer or user of the software application. Because ESD server 502 needs to receive user data, it is preferably connected to a user interface, such as a Web browser, that can be accessed by a retailer or a customer (a user or purchaser of the software application) at a point-of-sale 506.

In one embodiment, the hardware identification attribute of the hardware device is automatically determined for the purpose of generating the hardware signature. For example, a serial number stored in a ROM may be electronically and automatically detected when hardware device 508 is connected through network 500. Alternatively, the hardware identification attribute can be determined based on the user information provided to either ESD server 504 or signature server 502. To accomplish this, the servers 502, 504 maintain a database that contains records associating each sold hardware device with user information. After the user information containing a user identification is provided to the servers 502, 504, the hardware identification attribute is determined by matching the user identification to the database that has hardware identification attributes associated with respective user identifications.

As disclosed herein, exemplary DRM methods in accordance with the present disclosure use a digital cryptographic signature to carry out a function that is quite opposite to the conventional function of using a digital cryptographic signature. While the conventional function of using a digital cryptographic signature is for a receiving party to verify the identification of a signing entity, some DRM methods in accordance with the present disclosure use a digital cryptographic signature so that the signing party can verify the identity of a receiving entity (specifically, a hardware device). If the public key of the receiving entity matches the private key held by the signing party that created the hardware signature, then verification is successful. Accordingly, DRM methods of the invention take advantage of the physicality of the public key of the receiving entity (the hardware device).

This unique “reverse validation” of a digital cryptographic signature contributes to the effectiveness and simplicity of DRM methods in accordance with the present disclosure. Because the hardware signature is appended to the main code component of the software application to form a software application package, no separate DRM certificate is necessary to authorize a user to use a software application. The simplicity of digital hardware signature validation makes possible automated DRM methods and systems that lock a uniquely packaged software application to an authorized hardware device without requiring the user to remember or enter a license key or license code. Furthermore, the main code component of the software application does not need to be encrypted.

In the foregoing specification, the present disclosure is described with reference to specific embodiments thereof, but those skilled in the art will recognize that the present disclosure is not limited thereto. Various features and aspects of the above-described disclosure may be used individually or jointly. Further, the present disclosure can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method for digital rights management comprising:
providing a main code component having application code and data resources;
generating a security component including a hardware identification attribute; and
appending the security component to the main code component to form a software application package, such that when the software application package is installed on a hardware device, the software application is enabled if the hardware identification attribute is also present in the hardware device, and is disabled if the hardware identification attribute is not present in the hardware device.

2. The method of claim 1 wherein generating the security component comprises automatically determining the hardware identification attribute.

3. The method of claim 2 wherein automatically determining the hardware identification attribute comprises reading the hardware identification attribute stored in the hardware device.

4. The method of claim 2 wherein automatically determining the hardware identification attribute comprises matching a user identification with a database comprising hardware identification attributes associated with respective user identifications.

5. The method of claim 1 wherein the security component is a digital hardware signature generated using a data set and a first key.

6. The method of claim 5 wherein the data set comprises the hardware identification attribute.

7. The method of claim 5 wherein the digital hardware signature is validated by a second key stored on the hardware device.

8. The method of claim 5 wherein the digital hardware signature is validated by an encrypted authorization key, which in turn is validated by a second key stored on the hardware device.

9. The method of claim 5 wherein the data set used for generating the digital hardware signature comprises an application signature.

10. The method of claim 1 wherein the software application package is a downloadable executable file.

11. The method of claim 10 wherein the executable file is a PalmOS resource file (.prc).

12. The method of claim 1, wherein the security component is merged with the main code component such that the main code component cannot be separately executed even if the main code component is non-encrypted or decrypted.

13. The method of claim 1 wherein the hardware device is portable.

14. The method of claim 1 wherein the hardware device is a removable ROM or RAM device.

15. A software application comprising:
a main code component including application code and data resources; and
a security component appended to the main code component and including a hardware identification attribute such that the software application is enabled if installed on a hardware device having a matching hardware identification attribute and disabled if installed on any other hardware device.

16. The software application of claim 15 wherein the security component comprises a digital hardware signature generated using a data set and a first key.

17. The software application of claim 16 wherein the data set comprises the hardware identification attribute.

18. The software application of claim 16 wherein the digital signature is validated by a second key stored on the hardware device.

19. The software application of claim 16 wherein the digital signature is validated by an encrypted authorization key, which in turn is validated by a second key stored on the hardware device.

20. The software application of claim 16 wherein the data set used for generating the digital signature comprises an application signature.

21. The software application of claim 15 wherein the main code and the security component are packaged in a downloadable executable file.

22. The software application of claim 21 wherein the executable file is a PalmOS resource file (.prc).

23. The software application of claim 15 wherein the software application is wholly unexecutable when disabled.

24. The software application of claim 15 wherein the software application is partially executable when disabled.

25. The software application of claim 15 wherein the hardware identification attribute is unique to the hardware device.

26. The software application of claim 15 wherein the security component is merged with the main code component such that the main code component cannot be separately executed even if the main code component is non-encrypted or decrypted.

27. A digital rights management (DRM) system comprising:
a hardware device including a hardware identification attribute; and
a software application having a main code component and a security component appended to the main code component, the security component including a matching hardware identification attribute, such that the software application is enabled if installed on the hardware device and disabled if installed on a hardware device that does not include the matching hardware identification attribute.

28. The DRM system of claim 27 wherein the hardware identification attribute is unique to the hardware device, such that the software application is disabled if installed on any other hardware device.

29. The DRM system of claim 27 wherein the hardware device is portable.

30. The DRM system of claim 29 wherein the portable hardware device is handheld.

31. The DRM system of claim 27 wherein the hardware device is a removable ROM or RAM device.

32. The DRM system of claim 27 wherein the hardware identification attribute is a persistent attribute of the hardware device.

33. The DRM system of claim 32 wherein the persistent attribute is a serial number of the hardware device.

34. The DRM system of claim 32 wherein the persistent attribute is stored in a ROM memory element of the hardware device.

35. The DRM system of claim 27 wherein the security component is merged with the main code component such that the main code component cannot be separately executed even if the main code component is non-encrypted or decrypted.

36. A digital rights management (DRM) system comprising:
a first server configured to receive a set of user data and determine a hardware identification attribute therefrom; and
a second server configured to generate, upon a request from the first server, a digital hardware signature based on the set of user data and including the hardware identification attribute, and either of the first server or second servers being configured to append the digital hardware signature to a software application to form a software application package which is executable on a hardware device only when the hardware device has a matching hardware identification attribute.

37. The DRM system of claim 36 wherein the first server is an Electronic Software Distribution server storing the software application component, and the second server is a digital signature server storing private keys for generating the digital hardware signature.

38. The DRM system of claim 37 wherein the digital signature server is configured to return the generated digital hardware signature to the Electronic Software Distribution server to form the software application package.

39. The DRM system of claim 36 wherein the first server is connected to a user interface.

40. The DRM system of claim 39 wherein the user interface is a Web browser.

41. The DRM system of claim 36 wherein the first server is configured to distribute the software application package to a user.

42. The DRM system of claim 36 wherein the set of user data comprises a user identification, and the hardware identification attribute is determined by matching the user identification to a database comprising hardware identification attributes associated with respective user identifications.
